(19) United States
(12) Patent Application Publication
(10) Pub. No.: US 2025/0389744 A1
(43) Pub. Date: Dec. 25, 2025

(54) AUTOMATED TRANSFER OF PRESSURIZED FLUIDS

(71) Applicant: SAUDI ARABIAN OIL COMPANY, Dhahran (SA)

(72) Inventors: Mohammed Abdullah AL GHAMDI, Dhahran (SA); Mohammed Hussain AL BASHRAWI, Dhahran (SA)

(73) Assignee: SAUDI ARABIAN OIL COMPANY, Dhahran (SA)

(21) Appl. No.: 18/751,451

(22) Filed: Jun. 24, 2024

(51) Int. Cl. G01N 35/10

(52) U.S. Cl. CPC G01N 35/1067; G01N 35/1009

(57) ABSTRACT

A method of remotely transferring a fluid sample between a sample tank and an analysis tank includes mating the sample tank and the analysis tank to one or more sample transfer lines, the sample transfer lines in fluid communication with a transfer valve, initiating operation of an incompressible fluid pump in fluid communication with the sample tank to increase pressure within the sample tank and routing the fluid sample through the transfer valve and into the analysis tank at a constant rate. The method further includes pressurizing the analysis tank via the fluid sample routed through the transfer valve, overcoming a predetermined pressure threshold of a relief valve in fluid communication with the analysis tank, and outputting an incompressible fluid through an incompressible outlet line in fluid communication with the relief valve.

### FIELD OF THE DISCLOSURE

The present disclosure relates generally to downhole sampling of hydrocarbon reservoirs and, more particularly, to systems and methods for transferring fluid samples from bottom hole collection devices into surface analysis equipment.

### BACKGROUND OF THE DISCLOSURE

During oil and gas extraction operations, bottom hole samplers are commonly used to extract fluid samples from within a hydrocarbon wellbore and to transport the fluid samples to a surface location for analysis. These bottom hole samplers can include sample tanks that are designed to maintain the integrity of the fluid samples during extraction and transport operations. Once the bottom hole samplers arrive at the surface location, the fluid samples can be transferred from the sample tanks into analysis tanks to facilitate testing and analysis of the fluid samples. The analysis tanks can be designed to maintain the fluid samples in a highly pressurized state while the analysis tanks are used in one or more testing apparatuses.

Transferring the fluid samples between the sample and analysis tanks can expose operators to potentially harmful gases, as well as dangerously high pressures. Conventional transfer processes can require direct operator intervention, for example, to connect the tanks and to control various intermediate valves between the tanks. As such, any defects within the tanks, or any other part of the system used for the transfer process, can release potentially toxic gases, emit pressurized fluids, or cause catastrophic failure of the tanks in a working environment of the operator or operators. While the transfer process can often be performed in a controlled laboratory setting, in some cases, the transfer process can also be performed on-site at the hydrocarbon wellbore. In these cases, the transfer process can be further complicated by environmental factors, which can lead to further safety concerns.

Accordingly, systems and methods for the safe transfer of fluid samples between a sample tank and an analysis tank are desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a transfer system includes a sample tank containing a downhole fluid sample therein, the sample tank including an inlet port and a sample transfer port, an analysis tank including an outlet port and a sample transfer port fluidly coupled to the sample transfer port of the sample tank and a relief valve fluidly coupled to the outlet port of the analysis tank, the relief valve operable to prohibit flow through the outlet port when a pressure within the analysis tank is below a predetermined threshold and to permit flow through the outlet port when the pressure within the analysis tank is above the predetermined threshold. The transfer system further includes a fluid pump fluidly coupled to the inlet port of the sample tank, the fluid pump operable to inject an incompressible fluid into the sample tank and thereby displace the downhole fluid sample from the sample tank into the analysis tank through the sample transfer ports, and a controller disposed remotely from the sample tank and the analysis tank, the controller operably coupled to the fluid pump to initiate injection of the incompressible fluid into the sample fluid tank.

In another embodiment, a method of remotely transferring a fluid sample between a sample tank and an analysis tank includes mating the sample tank and the analysis tank to one or more sample transfer lines, the sample transfer lines in fluid communication with a transfer valve, initiating operation of an incompressible fluid pump in fluid communication with the sample tank to increase pressure within the sample tank, routing the fluid sample through the transfer valve and into the analysis tank at a constant rate, pressurizing the analysis tank via the fluid sample routed through the transfer valve, overcoming a predetermined pressure threshold of a relief valve in fluid communication with the analysis tank, and outputting an incompressible fluid through an incompressible outlet line in fluid communication with the relief valve.

In a further embodiment, a transfer system includes a base plate sized to house one or more components of the transfer system, a central support protruding vertically upwards from the base plate, one or more clamps mated to the central support and receiving a sample tank including a fluid sample and an analysis tank, and a transfer valve in fluid communication with the sample tank and the analysis tank via a sample transfer line. The transfer system further includes an incompressible fluid pump in fluid communication with the sample tank and operable to increase a pressure within the sample tank, a relief valve in fluid communication with the analysis tank operable to permit flow out of the analysis tank when a predetermined pressure threshold is reached within the analysis tank, and a controller operable to autonomously control the transfer valve, the incompressible fluid pump, the relief valve, and any combination thereof.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic view of a transfer system operable to autonomously perform an automated fluid sample transfer between a sample tank and an analysis tank, according to an embodiment consistent with the present disclosure.

FIG. 2A is a schematic view of the sample tank and analysis tank with piston assemblies included therein, according to at least one embodiment of the present disclosure.

FIG. 2B depicts example operation of the piston assemblies included within sample tank and analysis tank, according to at least one embodiment of the present disclosure.

FIG. 3 is a flowchart illustrating an example of a method for automated transfer of bottom hole fluid samples between a sample tank and an analysis tank, according to at least one embodiment of the present disclosure.

FIG. 4 illustrates one example of a computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to down hole sampling of hydrocarbon reservoirs and, more particularly, to systems and methods for transferring fluid samples from a fluid sample tank into analysis equipment. The systems and methods disclosed herein may enable remote and/or autonomous control of the sample transfer process, such that fine-tuned pressure control may be achieved with limited operator intervention. The disclosed embodiments may include controllable relief valves, transfer valves, and fluid pumps in communication with a controller and operable to control pressure and fluid flow within the transfer systems. The remote and/or autonomous transfer processes may limit exposure of operators to possibly harmful fluids and pressurized containers, and disclosed support structures and shielding can limit splashing and leaking of fluid samples during operation. Further, through the autonomous control of the transfer process, the transfer process may be expedited and stabilized. For example, autonomous control allows for fine control of pressures and flowrates, which may optimize the transfer of sample fluids between a sample tank and an analysis tank. As such, the disclosed methods and systems may increase efficiency of the transfer process while maintaining sample integrity and operator safety during the transfer.

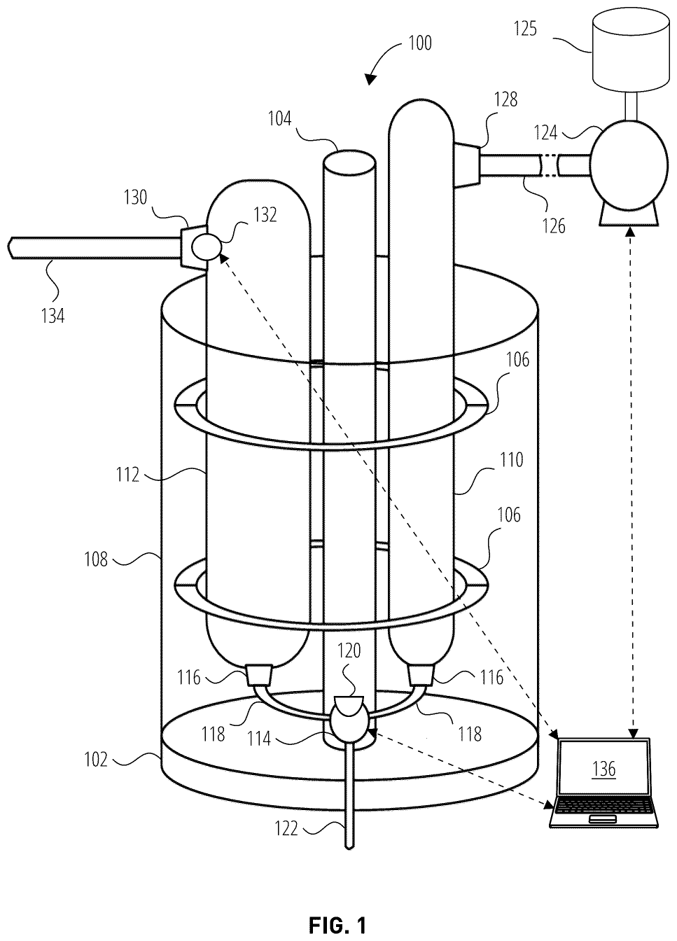

FIG. 1 is a schematic view of an example transfer system 100 operable to autonomously perform a fluid sample transfer with limited operator intervention, according to one or more embodiments consistent with the present disclosure. The transfer system 100 may be utilized in a laboratory setting for the transfer of a fluid sample in a controlled environment, or may be utilized on-site at a hydrocarbon-producing wellbore prior to shipping the fluid sample to a laboratory.

As illustrated, the transfer system 100 may include a base plate 102 from which other components of the transfer system 100 may be mounted and otherwise extend. The base plate 102 may be sized to support one or more components of the transfer system 100 thereabove, such that the base plate 102 may stably rest upon a flat surface.

The transfer system 100 may further include a central support 104 vertically protruding from the base plate 102, and the central support 104 may support a plurality of clamps 106 thereon. The clamps 106 may be operable for receiving and retaining one or more fluid tanks, e.g., a sample tank 110 and an analysis tank 112. The clamps 106 may retain the one or more fluid tanks in a vertical, upright position to enable density-based separation of fluids therein. In some embodiments, a contaminating fluid, such as water, may be included within the fluid tanks. In these embodiments, a vertical, upright position may enable the water to settle on a bottom of the fluid tank while a hydrocarbon sample floats on top, thus enabling removal of the water before extracting the hydrocarbon sample.

The transfer system 100 may additionally include a shield 108 surrounding central support 104 and clamps 106, wherein a bottom end of the shield 108 is mated (operatively coupled) to the base plate 102. In some embodiments, a top end of the shield 108 may be open to enable access to the central support 104 and clamps 106. In further embodiments, however, the top end of the shield 108 can be closed or sealed for isolation of an interior of the transfer system 100 from a surrounding environment. In some embodiments, the shield 108 may be formed of a transparent material to enable visual monitoring of the transfer process, and to visually detect any leaks within the transfer system 100. The shield 108 may be further formed of a high-strength material, such as a bullet-resistant polycarbonate, to protect nearby operators from failures within the transfer system 100.

The transfer system 100 may receive the sample tank 110 within the clamps 106, such that the sample tank 110 may be housed within the shield 108. The sample tank 110 may be received from a bottom hole sampler that actively retrieved a fluid sample from a bottom of a wellbore (not shown). In other embodiments, the sample tank 110 may be received from a sampler deployed at any other downhole locations, without departing from the scope of the disclosure. The sample tank 110 may be received within the clamp 106 along with an analysis tank 112 of the transfer system 100. As depicted, the sample tank 110 may be elongated, and may have a smaller diameter than the analysis tank 112, as the sample tank 110 may be designed to trip down (e.g., be conveyed down) the wellbore with the bottom hole sampler. The analysis tank 112 may have a length less than that of the sample tank 110, while further having a larger diameter than the sample tank 110 for easier handling by an operator. The analysis tank 112 may be similarly mounted within the shield 108, and may thereby be prepared to receive a sample from the sample tank 110 via the transfer system 100.

The transfer system 100 may further include a transfer valve 114 interposing the sample tank 110 and the analysis tank 112, such that the transfer valve 114 may control fluid transfer therebetween. The sample tank 110 and the analysis tank 112 may each include a sample transfer port 116 at a bottom end thereof that may facilitate transport of the fluid sample into and out of the sample tank 110 and analysis tank 112. The transfer valve 114 may be in fluid communication with the sample tank 110 and the analysis tank 112 via sample transfer lines 118 that may be mated to said sample transfer ports 116. In some embodiments, each of the sample transfer ports 116 and the transfer valve 114 may include a threaded nipple (or other threaded extension) that is threadably engageable with sample transfer lines 118. In the illustrated embodiment, the transfer valve 114 is housed within the central support 104, such that the transfer system 100 includes a compact design. However, in further embodiments, the transfer valve 114 may be externally located, or may be disposed elsewhere within the shield 108.

The transfer valve 114 may be operable to autonomously control flow of the fluid sample between the sample tank 110 and the analysis tank 112. The transfer valve 114 may include a sensor 120 therein, which may detect parameters indicative of the type of fluid received from the sample tank 110 during operation. In some embodiments, the sensor 120 may signal the presence of water, or another contaminating fluid, within the sample tank 110. The transfer valve 114 may accordingly route fluid flow from the sample tank 110 into a dumping line 122, in further fluid communication with the transfer valve 114, to remove the fluid from the transfer system 100. The transfer valve 114 may continue to provide the fluid flow through the dumping line 122 until the sensor 120 signals the presence of hydrocarbons within the transfer valve 114, thus providing a positive indication that the contaminating fluid has been successfully dumped (discharged) from the sample tank 110. The transfer valve 114 can accordingly route fluid flow through the sample transfer lines 118 and into the analysis tank 112 for collection of the hydrocarbon fluid sample without contaminants.

To autonomously control pressure and flow through the transfer system 100, an incompressible fluid pump 124 may be provided therein. The incompressible fluid pump 124 may be connected within the transfer system 100 via an incompressible fluid line 126, which may route an incompressible fluid into a top end of the sample tank 110. The incompressible fluid line 126 may be mated to an incompressible inlet port 128 of the sample tank 110 to provide fluid communication into the sample tank 110. As an incompressible fluid, such as glycol, is introduced into the sample tank 110 through the inlet port 128, the fluid sample may be displaced out of the sample tank 110 through the sample transfer port 116.

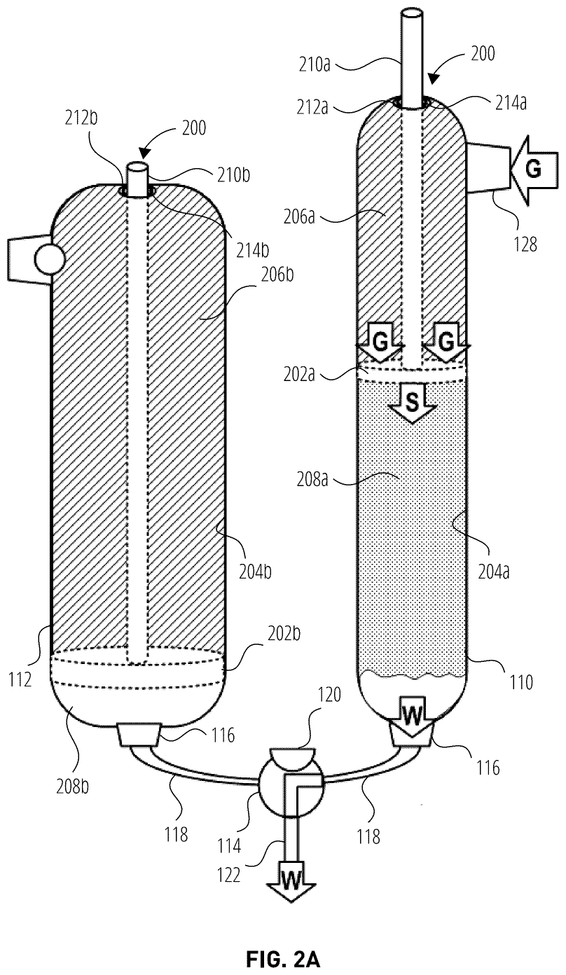

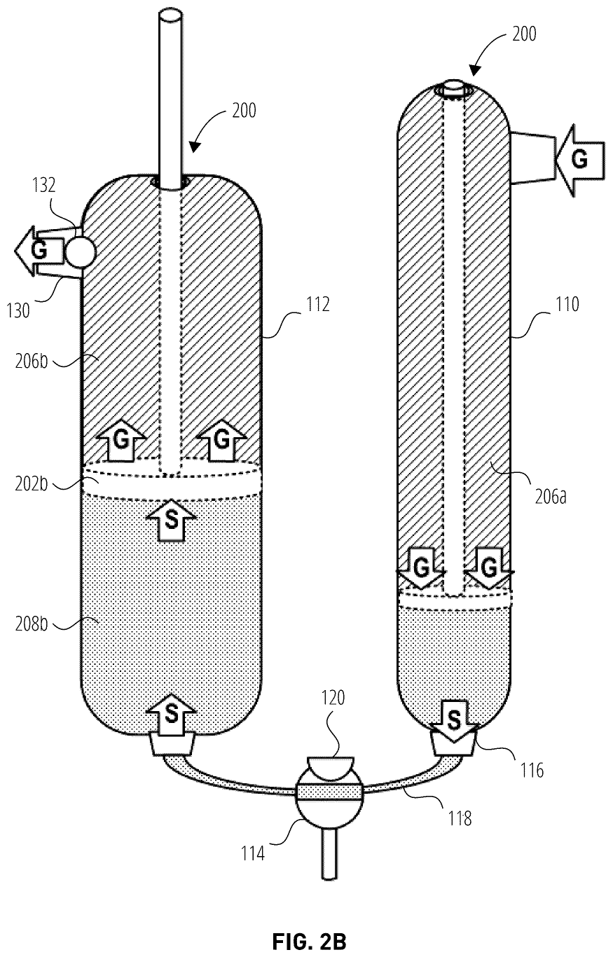

In some embodiments, as depicted in FIGS. 2A-2B, the sample tank 110 and analysis tank 112 may each include a piston assembly (e.g., piston assembly 200) therein. The piston assembly can prevent passage of fluids across a piston thereof, while driving fluid transfer between the sample tank 110 and/or analysis tank 112. In further embodiments, however, further pressurization assemblies may be utilized in control of the sample tank 110, such as one or more bladders, without departing from the scope of this disclosure.

The flow of an incompressible fluid into the sample tank 110 via the incompressible inlet port 128 can force the fluid sample from the sample tank 110 into the sample transfer line 118 via the sample transfer port 116. The fluid sample may be routed through the transfer valve 114 to the analysis tank 112, such that the fluid sample may begin filling the analysis tank. In some embodiments, the analysis tank 112 may include a similar pressurization assembly therein. As such, the insertion of the fluid sample into the analysis tank 112 may accordingly initiate outflow of an incompressible fluid from the analysis tank 112.

As the fluid sample enters the analysis tank 112, the increased pressure may force the incompressible fluid out through an incompressible outlet port 130 at a top of the analysis tank 112. In some embodiments, the incompressible outlet port 130 can include a relief valve 132 therein, such that the incompressible fluid may not flow out of the analysis tank 112 until a predetermined pressure is met. In these embodiments, the relief valve 132 may be chosen or controlled to further limit the flowrate of the fluid sample into the analysis tank 112. The relief valve 132 may enable fine control of the flow of the fluid sample through the incompressible outlet port 130, while the incompressible fluid pump 124 controls the flow from the input side of the transfer system 100.

The incompressible fluid may flow out of the incompressible outlet port 130 and into an incompressible outlet line 134, which may transport the incompressible fluid out of the transfer system 100. In some embodiments, however, the incompressible outlet line 134 may be in communication with a fluid source 125 which may be in fluid communication with the incompressible fluid pump 124. As such, the incompressible fluid may be included in a closed system that recycles the incompressible fluid that is expelled from the analysis tank 112 for insertion into the sample tank 110.

In some embodiments, as discussed above, operation of the transfer system 100 may be autonomously controlled. The transfer valve 114, the incompressible fluid pump 124, the relief valve 132, and any interconnected flow controls may be communicatively coupled to a controller 136. The controller 136 may be in communication with the incompressible fluid pump 124, the sensor 120, the transfer valve 114, the relief valve 132, and any other flow controls of the transfer system 100, via a wired connection and/or a wireless access point, and may send and receive signals to monitor and actuate the communicatively coupled components. In some embodiments, an operator may insert the sample tank 110 and/or analysis tank 112 within the clamps 106, mate sample transfer lines 118 to sample transfer ports 116 and connect the incompressible fluid lines 126, 134 to the inlet and outlet ports 128, 130. Thereafter, the operator may utilize controller 136 for remote control of the transfer system 100, and/or may monitor operation of the transfer system 100 with the controller 136 as the controller 136 autonomously controls the operation of the transfer system.

FIG. 2A is a schematic view of the sample tank 110 and analysis tank 112 with piston assemblies 200 included therein, according to at least one embodiment of the present disclosure. The piston assembly 200 may be included within the sample tank 110 and/or analysis tank 112, such that piston heads 202a-b are fully disposed within. The piston heads 202a-b may be sized to abut (engage) internal circumferential surfaces 204a-b of the sample tank 110 or analysis tank 112, respectively, such that a seal may be generated between the piston heads 202a-b and the internal circumferential surfaces 204a-b. In some embodiments, the piston heads 202a-b may include a sealant material on an outer diameter thereof, such as a rubber coating, to further aid in generating a seal. The piston heads 202a-b may accordingly separate two sides of the sample tank 110 or analysis tank 112, i.e., an incompressible fluid side 206a-b and a sample side 208a-b.

The piston assembly 200 may further include a piston shaft 210a-b mated to the corresponding piston heads 202a-b, and protruding therefrom. The piston shafts 210a-b may travel along with the piston heads 202a-b, and may further protrude from the sample tank 110 or analysis tank, respectively. The piston shafts 210a-b may aid in maintaining a central position of the piston heads 202a-b as pressure changes on the incompressible fluid sides 206a-b and the sample sides 208a-b. The piston shafts 210a-b may accordingly protrude through a shaft port 212a-b defined on one end of the sample tank 110 or analysis tank 112, which may be sized with a diameter similar to that of the piston shafts 210a-b. The shaft ports 212a-b may receive and retain the piston shafts 210a-b therethrough, such that the piston shafts 210a-b and the connected piston heads 202a-b are unable to rotate or pivot within the sample tank 110 or analysis tank 112. The shaft ports 212a-b may further include shaft seals 214a-b therein to prevent leaks through the shaft ports 212a-b and to maintain pressurization.

An example initial operation of the sample tank 110 and transfer valve 114 is depicted in FIG. 2A, such that an incompressible fluid, shown here as glycol “G”, may enter the sample tank 110 via the incompressible inlet port 128. The flow of glycol “G” into the sample tank 110 from the incompressible fluid pump 124 of FIG. 1 may cause pressure to build within the incompressible fluid side 206a of the sample tank 110. As the pressure builds, the glycol “G” may begin to exert pressure on one side of the piston head 202a. The pressure within the incompressible fluid side 206a may build until the piston head 202a and piston shaft 210a begin to translate vertically downwards towards the sample side 208a.

In the illustrated embodiment, a contaminating fluid, shown here as water “W”, may be present within a bottom of sample tank 110. As the piston shaft 210a and piston head 202a translate towards the sample side 208a, pressure may begin to build in sample side 208a, such that the water “W” may be pushed through sample transfer port 116 and sample transfer line 118. The sensor 120 within the transfer valve 114 may detect the presence of water “W” within the transfer valve 114, and may signal for the transfer valve 114 to divert the water “W” to dumping line 122, as shown. Glycol “G” may continue to flow into the incompressible fluid side 206a as the water “W” is drained from the sample tank 110.

FIG. 2B depicts example operation of the piston assemblies 200 included within sample tank 110 and analysis tank 112, according to at least one embodiment of the present disclosure. In FIG. 2B, any contaminating fluids have been removed from the sample tank 110, and further pumping of glycol “G” into the incompressible fluid side 206a may push sample “S” through the sample transfer port 116 and sample transfer line 118. As the sample “S” reaches the transfer valve 114, the sensor 120 may detect an absence of water “W” therein, and may accordingly route the incoming fluid to the analysis tank 112, as shown.

Sample “S” may pass through the transfer valve 114 and into the sample side 208b of the analysis tank 112. As sample “S” enters sample side 208b, a pressure on the sample side 208b may begin to act upon the piston head 202b. The building pressure on the sample side 208b and piston head 202b may pressurize the incompressible fluid side 206b of the analysis tank 112. Once pressure within the incompressible fluid side 206b reaches a desired or designed threshold, the relief valve 132 may permit flow into the incompressible outlet port 130. Glycol “G” may flow through relief valve 132 and incompressible outlet port 130 to exit the analysis tank 112, and may accordingly reduce pressure within the incompressible side 206b.

Continuous pumping of glycol “G” into incompressible side 206a of the sample tank 110 may continue to push sample “S” into the analysis tank 112, and may in turn push glycol “G” out of the incompressible side 206b. Once a desired amount of sample “S” has been transferred into the analysis tank 112, or once the piston assemblies 200 have reached a full travel of one or more of the piston shafts 210a-b, pumping of glycol “G” may cease. Without further application of pressure to piston assemblies 200, transfer of sample “S” may be stopped and flow control components may prevent backflow or leaks. As such, each of the sample tank 110 and analysis tank 112 may then be removed from the system 100 of FIG. 1 for further use.

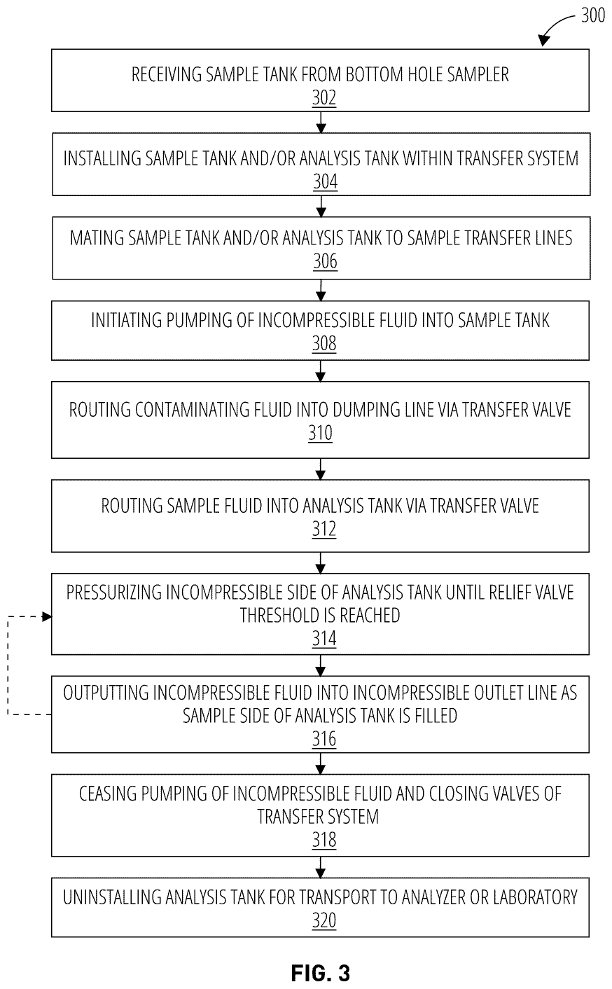

In view of the structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 3 is a flowchart illustrating an example method 300 for automated transfer of bottom hole fluid samples (or other downhole fluid samples) between a sample tank and an analysis tank, according to at least one embodiment of the present disclosure. The method 300 can be implemented by the transfer system 100, as shown in FIG. 1. Thus, reference can be made to the example transfer system of FIGS. 1-2B in the example method of FIG. 3. Further, in some embodiments, the method 300 may be at least partially automated via the controller 136 of FIG. 1, such that the method 300 is a computer-implemented method. The method 300 can begin at 302 by receiving a sample tank (e.g., the sample tank 110) from a bottom hole sampler. The bottom hole sampler may transport the sample tank to a depth of a hydrocarbon wellbore for collection of a fluid sample, as well as any contaminating fluid, for transport to the surface. The sample tank may accordingly include a pressurized fluid sample therein on a sample side (e.g., the sample side 208) of the sample tank.

The method 300 may further include installing the sample tank and/or an analysis tank (e.g., the analysis tank 112) within a transfer system (e.g., the transfer system 100) at 304. The installation of the sample tank and/or analysis tank at 304 may include mounting the tanks on one or more clamps (e.g., the clamps 106) mounted on a central support (e.g., the central support 104) of the transfer system. The method 300 may continue at 306 with mating the sample tank and/or the analysis tank to sample transfer lines (e.g., the sample transfer lines 118) via one or more sample transfer ports (e.g., the sample transfer ports 116) of the tanks. In some embodiments, the sample transfer lines may include threaded connections for mating with the pressurized tanks to reduce leaks and maintain pressurization within the tanks. The mating of the sample transfer lines to the tanks may enable flow of the fluid sample across the sample transfer lines and into the analysis tank from the sample tank.

Accordingly, the method 300 may continue at 308 with initiating pumping of an incompressible fluid, such as glycol, into the sample tank. The pumping of the incompressible fluid may be provided by an incompressible fluid pump (e.g., the incompressible fluid pump 124) that may be remotely or autonomously controlled. The incompressible fluid pump may provide the incompressible fluid into an incompressible fluid side (e.g., the incompressible fluid side 206) of the sample tank, to actuate a pressurizing assembly therein. In some embodiments, the pressurizing assembly may be a piston assembly (e.g., the piston assembly 200) which may travel within the sample tank as pressurization occurs. Pressurization of the sample tank may urge the fluid sample out of the sample tank and into the sample transfer lines as the incompressible fluid continues to build in the sample tank.

The method 300 may continue at 310 with routing a contaminating fluid, such as water, through the transfer valve and into a dumping line (e.g., the dumping line 122). In some embodiments, the contaminating fluid may be denser than the fluid sample, and will therefore be the first fluid ejected from a bottom of the vertically oriented sample tank. Accordingly, the initial contaminating fluid may be routed into the dumping line and removed from the system. In some embodiments, the transfer valve may include a sensor (e.g., the sensor 120) therein. The sensor may detect the presence of a contaminating fluid or a hydrocarbon, and may signal to a controller (e.g., the controller 136) accordingly. The transfer valve may continue to transfer the incoming fluid into the dumping line until the sensor detects a change in the fluid composition within the transfer valve. Accordingly, the method 300 may continue at 312 with routing the sample fluid into the analysis tank via the transfer valve. Once the sensor has detected the presence of hydrocarbons and/or the sample fluid, the transfer valve may be signaled to enable fluid flow between the sample transfer lines. The sample fluid may, accordingly, flow across the transfer valve and may begin entering the analysis tank.

The method 300 may continue at 314 with pressurizing the analysis tank until a pressure threshold is reached within a relief valve (e.g., the relief valve 132) on an incompressible fluid side of the analysis tank. The relief valve may be included within an incompressible outlet port (e.g., the incompressible outlet port 130) in communication with an incompressible outlet line (e.g., the incompressible outlet line 134), and may prevent flow therethrough until the required pressure is reached. As discussed above, the analysis tank may include a piston assembly therein for internal pressurization between the sample side and the incompressible fluid side. Accordingly, as the sample side begins to fill with the fluid sample, the incompressible fluid side may increase in pressure until the relief valve is opened. In this way, the flow and pressurization between the sample tank and the analysis tank may be finely controlled to prevent rapid depressurization or other failures. In some embodiments, the relief valve may be remotely or autonomously controlled via the controller mentioned above.

The method 300 may continue at 316 with outputting the incompressible fluid into the incompressible outlet line as the sample side of the analysis tank is filled. In some embodiments, the sample side of the analysis tank may be incrementally filled, as the relief valve is cyclically opened and closed as pressure changes. In further embodiments, however, the relief valve may remain open after reaching the predetermined threshold and flow may continuously occur. The method 300 may continue at 318 with ceasing the pumping of the incompressible fluid and closing of the valves of the transfer system. Upon reaching a desired fill level within the analysis tank, the incompressible fluid pump may be deactivated and the valves of the transfer system may be closed to cease any further flow between the sample tank and analysis tank. In some embodiments, the remaining fluids within the sample tank may be routed through the transfer valve and into the dumping line to remove any leftover fluids.

Once the flow between the sample tank and analysis tank has ceased, the method 300 may continue at 320 with uninstalling the analysis tank for transport to an analyzer located on-site, or for transport to an off-site laboratory. The filled analysis tank may be accordingly unmated from the sample transfer lines and the incompressible fluid lines, such that the analysis tank may be sealed and pressurized. The desired tests and analysis may then be performed on the fluid sample within the analysis tank, and the process may be repeated for a new sample tank. As discussed above, the method 300 may be partially automated, such that the steps 308-318 may be performed by a controller. The automation of the method 300 may enable consistent and smooth fluid transfer between the tanks while limiting operator exposure to the highly-pressurized fluids and gases used therein.

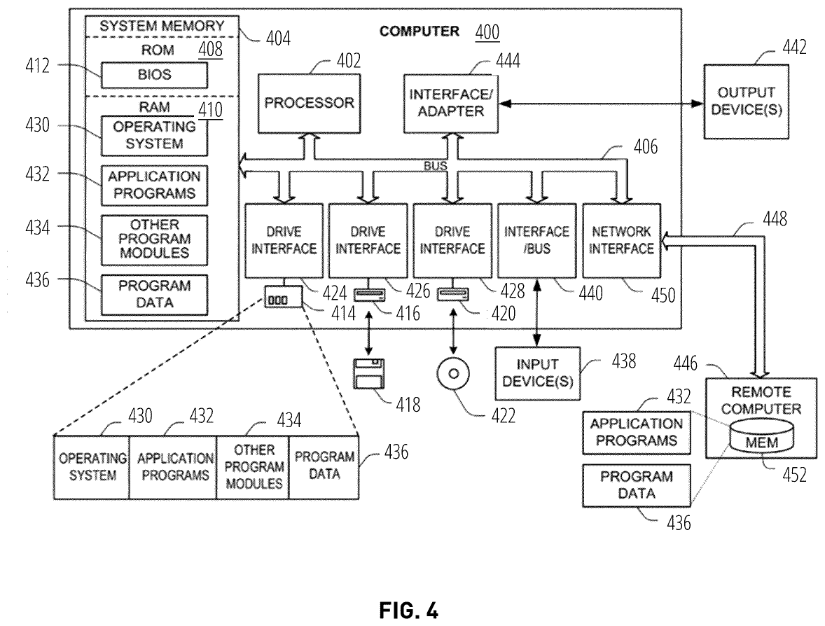

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. §101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 408 and random access memory (RAM) 410. A basic input/output system (BIOS) 412 can reside in ROM 408 containing the basic routines that help to transfer information among elements within computer system 400.

Computer system 400 can include a hard disk drive 414, magnetic disk drive 416, e.g., to read from or write to removable disk 418, and an optical disk drive 420, e.g., for reading CD-ROM disk 422 or to read from or write to other optical media. Hard disk drive 414, magnetic disk drive 416, and optical disk drive 420 are connected to system bus 406 by a hard disk drive interface 424, a magnetic disk drive interface 426, and an optical drive interface 428, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 408, including operating system 430, one or more application programs 432, other program modules 434, and program data 436. In some examples, the application programs 432 can include control software within the controller 136 for reading signals of the sensor 120, actuating the transfer valve 114 and relief valve 132, and operating the incompressible fluid pump 124, and the program data 436 can include any of the readings of sensor 120, any flowrate data from the incompressible fluid pump 124, and any combination thereof. The application programs 432 and program data 436 can include functions and methods programmed to autonomously control a fluid transfer process between a sample tank 110 and an analysis tank 112, such as shown and described herein.

A user may enter commands and information into computer system 400 through one or more input device 438, such as a pointing device (e.g., a mouse, touch screen), keyboard, microphone, joystick, game pad, scanner, and the like. For instance, the user can employ input device 438 to edit or modify the predetermined threshold for the relief valve 132, the flowrate of the incompressible fluid pump 124, the actuation of the transfer valve 114, and any combination thereof. These and other input devices 438 are often connected to processing unit 402 through a corresponding port interface 440 that is coupled to the system bus, but may be connected by other interfaces, such as a parallel port, serial port, or universal serial bus (USB). One or more output devices 442 (e.g., display, a monitor, printer, projector, or other type of displaying device) is also connected to system bus 406 via interface 444, such as a video adapter.

Computer system 400 may operate in a networked environment using logical connections to one or more remote computers, such as remote computer 446. Remote computer 446 may be a workstation, computer system, router, peer device, or other common network node, and typically includes many or all the elements described relative to computer system 400. The logical connections, schematically indicated at 448, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 450. When used in a WAN networking environment, computer system 400 can include a modem, or can be connected to a communications server on the LAN. The modem, which may be internal or external, can be connected to system bus 406 via an appropriate port interface. In a networked environment, application programs 432 or program data 436 depicted relative to computer system 400, or portions thereof, may be stored in a remote memory storage device 452.

Embodiments disclosed herein include:
A. A transfer system including a sample tank containing a downhole fluid sample therein, the sample tank including an inlet port and a sample transfer port, an analysis tank including an outlet port and a sample transfer port fluidly coupled to the sample transfer port of the sample tank, a relief valve fluidly coupled to the outlet port of the analysis tank, the relief valve operable to prohibit flow through the outlet port when a pressure within the analysis tank is below a predetermined threshold and to permit flow through the outlet port when the pressure within the analysis tank is above the predetermined threshold, a fluid pump fluidly coupled to the inlet port of the sample tank, the fluid pump operable to inject an incompressible fluid into the sample tank and thereby displace the downhole fluid sample from the sample tank into the analysis tank through the sample transfer ports, and a controller disposed remotely from the sample tank and the analysis tank, the controller operably coupled to the fluid pump to initiate injection of the incompressible fluid into the sample fluid tank.
B. A method of remotely transferring a fluid sample between a sample tank and an analysis tank, the method including mating the sample tank and the analysis tank to one or more sample transfer lines, the sample transfer lines in fluid communication with a transfer valve, initiating operation of an incompressible fluid pump in fluid communication with the sample tank to increase pressure within the sample tank, routing the fluid sample through the transfer valve and into the analysis tank at a constant rate, pressurizing the analysis tank via the fluid sample routed through the transfer valve, overcoming a predetermined pressure threshold of a relief valve in fluid communication with the analysis tank, and outputting an incompressible fluid through an incompressible outlet line in fluid communication with the relief valve.
C. A transfer system including a base plate sized to house one or more components of the transfer system, a central support protruding vertically upwards from the base plate, one or more clamps mated to the central support and receiving a sample tank including a fluid sample and an analysis tank, a transfer valve in fluid communication with the sample tank and the analysis tank via a sample transfer line, an incompressible fluid pump in fluid communication with the sample tank and operable to increase a pressure within the sample tank, a relief valve in fluid communication with the analysis tank operable to permit flow out of the analysis tank when a predetermined pressure threshold is reached within the analysis tank, and a controller operable to autonomously control the transfer valve, the incompressible fluid pump, the relief valve, and any combination thereof.

Each of embodiments A through C may have one or more of the following additional elements in any combination: Element 1: further comprising a transfer valve fluidly coupled between the sample transfer ports of the sample tank and the analysis tank, the transfer valve operably coupled to the controller to selectively prohibit and permit flow from the sample tank into the analysis tank. Element 2: wherein the transfer valve includes a sensor operable to send a signal to the controller denoting a type of fluid present within the transfer valve. Element 3: wherein the controller is operable to actuate the transfer valve to route a contaminating fluid into a dumping line and to route the fluid sample into the analysis tank based upon the signal received from the sensor. Element 4: further comprising: a base plate sized to support one or more components of the transfer system thereon; a central support protruding vertically upwards from the base plate; and one or more clamps mated to the central support for retaining the sample tank and the analysis tank above the base plate. Element 5: further comprising a shield mated to the base plate and at least partially surrounding the central support, sample tank, and analysis tank. Element 6: wherein the relief valve is operably coupled to the controller such that the predetermined threshold may be adjusted by the controller. Element 7: wherein each of the sample tank and the analysis tank include a piston assembly therein, the piston assembly including a piston head dividing each of the sample tank and the analysis tank into an incompressible fluid side and a sample side. Element 8: wherein the incompressible fluid pump is in fluid communication with the incompressible fluid side of the sample tank, and wherein pumping of an incompressible fluid into the sample tank translates the piston head in the sample tank to displace the downhole fluid sample from the sample side of the sample tank.

Element 9: wherein receiving the fluid sample in the sample side of the analysis tank translates the piston head in the analysis tank to pressurize the incompressible fluid side of the analysis tank and actuate the relief valve. Element 10: further comprising receiving a signal in a controller from a sensor at or near the transfer valve, the signal denoting a type of fluid present within the transfer valve. Element 11: further comprising routing a contaminating fluid through the transfer valve and into a dumping line based upon the signal received in the controller. Element 12: further comprising autonomously initiating and ceasing operation of the incompressible fluid pump and autonomously actuating the transfer valve and relief valve with the controller. Element 13: further comprising receiving the sample tank and analysis tank within one or more clamps of the transfer system to retain the sample tank and analysis tank in a desired position. Element 14: further comprising installing the sample tank and the analysis tank within a shield of the transfer system. Element 15: further comprising visually monitoring operation of the transfer system through the shield of the transfer system, wherein the shield is formed of a transparent material. Element 16: further comprising a sensor housed at or near the transfer valve and operable to detect a type of fluid present within the transfer valve, wherein the sensor provides a signal to the controller denoting the type of fluid. Element 17: further comprising a dumping line in fluid communication with the transfer valve, wherein the controller actuates the transfer valve between a first position connecting the sample tank to the analysis tank, and a second position connecting the sample tank to the dumping line based upon the signal from the sensor.

By way of non-limiting example, exemplary combinations applicable to A through C include: Element 1 with Element 2; Element 2 with Element 3; Element 4 with Element 5; Element 7 with Element 8; Element 8 with Element 9; Element 10 with Element 11; Element 10 with Element 12; Element 14 with Element 15; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A transfer system, comprising:
a sample tank configured to contain a downhole fluid sample and including an inlet port and a sample transfer port;
an analysis tank including an outlet port and a sample transfer port fluidly coupled to the sample transfer port of the sample tank;
a relief valve arranged in the outlet port of the analysis tank and operable to prohibit flow through the outlet port when a pressure within the analysis tank is below a predetermined threshold and to permit flow through the outlet port when the pressure within the analysis tank exceeds the predetermined threshold;
a fluid pump fluidly coupled to the inlet port of the sample tank and operable to inject an incompressible fluid into the sample tank and thereby displace the downhole fluid sample from the sample tank into the analysis tank through the sample transfer ports; and
a controller disposed remotely from the sample tank and the analysis tank and in communication with the fluid pump to initiate injection of the incompressible fluid into the sample fluid tank.

2. The transfer system of claim 1, further comprising a transfer valve fluidly coupled between the sample transfer ports of the sample tank and the analysis tank, the transfer valve operably coupled to the controller to selectively prohibit and permit flow from the sample tank into the analysis tank.

3. The transfer system of claim 2, wherein the transfer valve includes a sensor operable to send a signal to the controller indicative of a type of fluid present within the transfer valve.

4. The transfer system of claim 3, wherein the controller is operable to actuate the transfer valve to route a contaminating fluid into a dumping line and to route the fluid sample into the analysis tank based upon the signal received from the sensor.

5. The transfer system of claim 1, further comprising:
a base plate sized to support one or more components of the transfer system thereon;
a central support protruding vertically upwards from the base plate; and
one or more clamps mated to the central support for retaining the sample tank and the analysis tank above the base plate.

6. The transfer system of claim 5, further comprising a shield operatively coupled to the base plate and at least partially surrounding the central support, the sample tank, and the analysis tank.

7. The transfer system of claim 1, wherein the relief valve communicates with the controller such that the predetermined threshold may be adjusted by the controller.

8. The transfer system of claim 1, wherein the sample tank and the analysis tank each include a piston assembly therein, the piston assembly including a piston head dividing each of the sample tank and the analysis tank into an incompressible fluid side and a sample side.

9. The transfer system of claim 8, wherein the incompressible fluid pump is in fluid communication with the incompressible fluid side of the sample tank, and wherein pumping an incompressible fluid into the sample tank causes the piston head in the sample tank to move and thereby displace the downhole fluid sample from the sample side of the sample tank.

10. The transfer system of claim 9, wherein receiving the fluid sample in the sample side of the analysis tank causes the piston head in the analysis tank to move and thereby pressurize the incompressible fluid side of the analysis tank and actuate the relief valve.

11. A method of remotely transferring a fluid sample between a sample tank and an analysis tank, the method comprising:
mating the sample tank and the analysis tank to one or more sample transfer lines in fluid communication with a transfer valve;
operating an incompressible fluid pump in fluid communication with the sample tank to increase pressure within the sample tank;
routing the fluid sample through the transfer valve and into the analysis tank at a constant rate;
pressurizing the analysis tank via the fluid sample routed through the transfer valve;
overcoming a predetermined pressure threshold of a relief valve in fluid communication with the analysis tank; and
outputting an incompressible fluid through an incompressible outlet line in fluid communication with the relief valve.

12. The method of claim 11, further comprising receiving a signal in a controller from a sensor at or near the transfer valve, the signal being indicative a type of fluid present within the transfer valve.

13. The method of claim 12, further comprising routing a contaminating fluid through the transfer valve and into a dumping line based upon the signal received in the controller.

14. The method of claim 12, further comprising autonomously initiating and ceasing operation of the incompressible fluid pump and autonomously actuating the transfer valve and the relief valve with the controller.

15. The method of claim 11, further comprising receiving the sample tank and the analysis tank within one or more clamps of the transfer system and thereby retaining the sample tank and the analysis tank in a desired position.

16. The method of claim 11, further comprising installing the sample tank and the analysis tank within a shield of the transfer system.

17. The method of claim 16, wherein the shield is formed of a transparent material and the method further comprises visually monitoring operation of the transfer system through the shield.

18. A transfer system comprising:
a base plate sized to support one or more components of the transfer system;
a central support protruding vertically upwards from the base plate;
one or more clamps operatively coupled to the central support and configured to receiving and secure a sample tank including a fluid sample and an analysis tank;
a transfer valve in fluid communication with the sample tank and the analysis tank via a sample transfer line;
an incompressible fluid pump in fluid communication with the sample tank and operable to increase a pressure within the sample tank;
a relief valve in fluid communication with the analysis tank and operable to permit flow out of the analysis tank when a predetermined pressure threshold is reached within the analysis tank; and
a controller operable to autonomously control the transfer valve, the incompressible fluid pump, and the relief valve.

19. The transfer system of claim 18, further comprising a sensor housed at or near the transfer valve and operable to detect a type of fluid present within the transfer valve, wherein the sensor provides a signal to the controller denoting the type of fluid.

20. The transfer system of claim 19, further comprising a dumping line in fluid communication with the transfer valve, wherein the controller actuates the transfer valve between a first position connecting the sample tank to the analysis tank, and a second position connecting the sample tank to the dumping line based upon the signal from the sensor.
